(19) United States
(12) Patent Application Publication
(10) Pub. No.: US 2010/0054838 A1
(43) Pub. Date: Mar. 4, 2010

(54) PRINTING APPARATUS AND PRINTING MEDIUM CONVEYING CONTROL METHOD IN PRINTING APPARATUS

(75) Inventors: Toshiyuki Nakanishi, Souraku-gun (JP); Makoto Hashimoto, Daito-shi (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SEIKO EPSON CORPORATION, Tokyo (JP)

(21) Appl. No.: 12/549,802

(22) Filed: Aug. 28, 2009

(30) Foreign Application Priority Data
Aug. 28, 2008 (JP) 2008-219902

(51) Int. Cl. B41J 15/00

(52) U.S. Cl. 400/619

(57) ABSTRACT

A printing apparatus that feeds a printing medium to a printing position and executes a printing processing is provided. In the printing apparatus, a paper feed operation performed when the rear end of the printing medium is positioned in the vicinity of a paper feed roller can be conducted accurately without hindering the printing operation. The printing apparatus that feeds a printing medium to a printing position and executes a printing processing, includes: a conveying unit that performs conveying of the printing medium including the paper feed operation and that has a paper feed roller provided before a position in which the printing processing is performed in the conveying direction; and a control unit that controls the printing processing and the conveying processing.

### CROSS-REFERENCE TO RELATED APPLICATIONS

This application is based upon and claims the benefit of priority from the prior Japanese Patent Application No. 2008-219902, filed on Aug. 28, 2008, the entire contents of which are incorporated herein by reference.

### BACKGROUND OF THE INVENTION

1. Field of the Invention

The present invention relates to a printing apparatus that feeds a printing medium to a printing position and executes a printing processing, and more particularly to a printing apparatus in which a paper feed operation performed when the rear end of the printing medium is positioned in the vicinity of a paper feed roller can be conducted accurately without hindering the printing operation.

2. Description of the Related Art

In a serial printer, for example an ink jet printer, a paper supply unit, a paper feed device such as a paper feed roller, and a paper discharge device such as a paper discharge roller are usually provided in the order of description in the conveying direction in a printing medium conveying system, and printing processing on the printing medium is executed between the paper feed roller and the paper discharge roller. In such a conveying system, the printing medium is supplied from the paper supply device, and the supplied printing medium is set so that the portion that is the very first to be printed is brought into the printing position by the paper feed device. The paper feed operation is thereafter successively and repeatedly executed by the paper feed device correspondingly to the length to be printed in one cycle, and once the printing processing on the printing medium is completed, the printing medium that has been subjected to printing is discharged by the paper discharge device.

When printing is performed in such an apparatus, in a printing mode in which the printing processing is performed till the very last portion of the printing medium, such as a marginless printing mode in which the printing is performed on the printing medium without margins, the rear end of the printing medium can reach the vicinity of the paper feed roller in the course of the printing processing. In the vicinity of the paper feed roller, when the rear end of the printing medium separates from the paper feed roller, a force that pushes the printing medium out of the roller acts upon the printing medium and the position of the printing medium can be displaced, for example, the printing medium can be outputted forward the position to which it has to be moved by the paper feed operation. The resultant problem is that in a case where the printing processing is performed even when the rear end of the printing medium reaches the vicinity of the paper feed roller, the printing position can be displaced and printing quality is degraded.

Several means for resolving the above-described problems have been suggested. Thus, with consideration for the application of the force that pushes the printing medium from the roller, Japanese Patent Application Laid-open No. 2001-246799 discloses a method of stopping the recording paper against the action of this force when the rear end of the recording paper reaches the vicinity of the roller.

However, in the contents described in Japanese Patent Application Laid-open No. 2001-246799, control is performed to stop the recording paper, and a problem is apparently associated with feeding the recording paper to the accurate position.

Further, when the position of the printing medium such as recording paper after it has been fed is matched accurately with the target position, because of mechanical accuracy of the device that moves the printing medium, it may be necessary to perform control by repeatedly moving the recording medium back and forth through the target position. Such a situation is undesirable because the alignment operation causes vibrations and noise associated therewith, without resulting in convergence.

The aforementioned situation is also undesirable because if the control conducted to align the position after the paper feed with the target position takes much time, the throughput of the printing apparatus decreases.

Therefore, alignment control is desirable such that it ensures certain accuracy, while causing not problems in other aspects.

### SUMMARY OF THE INVENTION

It is an object of the present invention to provide a printing apparatus that feeds a printing medium to a printing position and executes a printing processing, wherein a paper feed operation performed when the rear end of the printing medium is positioned in the vicinity of a paper feed roller can be conducted accurately without hindering the printing operation.

To achieve this object, a first aspect of the present invention is that a printing apparatus that feeds a printing medium to a printing position and executes a printing processing, includes: a conveying unit that performs conveying of the printing medium including the paper feed operation and that has a paper feed roller provided before a position in which the printing processing is performed in the conveying direction; and a control unit that controls the printing processing and the conveying processing, and the control unit executes a position correction processing for moving a position of a rear end of the recording medium to a target position in a case where the position of the rear end is shifted from the target position when the position of the rear end after the paper feed operation is within a predetermined range in the vicinity of the paper feed roller and ends the position correction processing when the number of times the back and forth relationship of the rear end position and the target position in the conveying direction is reversed reaches a predetermined number of times.

According to one embodiment of the invention, the predetermined number of times the back and forth relationship is reversed is one.

Also in the present invention, it is preferable that the position correction processing is performed by voltage application to a motor that rotates the paper feed roller, and once the position correction processing ends, in a case where the rear end is before the target position in the conveying direction prior to the position correction processing, a voltage of a predetermine value that causes no movement of the printing medium and that is in the direction of causing the paper feed roller to rotate in the conveying direction is applied to the motor, and in a case where the rear end is after the target position in the conveying direction prior to the position correction processing, the voltage of the predetermined value is not applied.

Also in the present invention, it is further preferable that the position correction processing after the paper feed operation is not performed in a case where a paper feed amount in the paper feed operation is not a preset value.

Also in the present invention, it is preferable that the position correction processing is not executed in a case where the printing processing is not performed in a predetermined printing mode.

To achieve the above described object, another aspect of the present invention is in a printing medium conveying control method in a printing apparatus that feeds a printing medium to a printing position and executes a printing processing, the printing apparatus is provided with a conveying unit that performs conveying of the printing medium including the paper feed operation and that has a paper feed roller provided before a position in which the printing processing is performed in the conveying direction, and a control unit that controls the printing processing and the conveying processing, and the control unit executes a position correction processing for moving a position of a rear end of the recording medium to a target position in a case where the position of the rear end is shifted from the target position when the position of the rear end after the paper feed operation is within a predetermined range in the vicinity of the paper feed roller, and ends the position correction processing when the number of times the back and forth relationship of the rear end position and the target position in the conveying direction is reversed reaches a predetermined number of times.

Other objects and advantages of the present invention will become apparent from the detailed description to follow taken in conjunction with the appended description of embodiments.

### BRIEF DESCRIPTION OF DRAWINGS

FIG. 1 is a structural diagram illustrating an embodiment of a printer that is a printing apparatus using the present invention;

FIGS. 2A and 2B are side views schematically showing the conveying system of the printer 2;

FIG. 3 is a flowchart showing an example of the contents of processing relating to the conveying processing performed by the CPU 22;

FIG. 4 is a flowchart illustrating by way of example the sequence of the determination processing preceding the paper feed operation;

FIG. 5 is a side enlarged view of the vicinity of the paper feed roller 33; and

FIG. 6 is a flowchart illustrating by way of example the sequence of the voltage control processing.

### DESCRIPTION OF EXEMPLARY EMBODIMENTS

Embodiments of the present invention will now be described with reference to the accompanying drawings. However, the protective scope of the present invention covers the inventions defined in the claims and their equivalents, but is not limited to the above embodiments. The same reference numerals in the drawings are used to denote and identify corresponding or identical components.

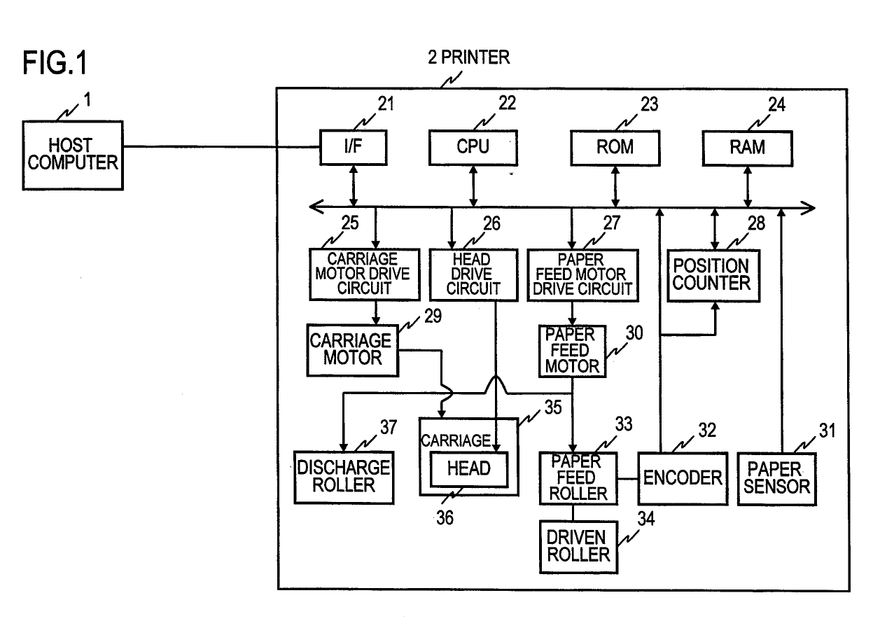

FIG. 1 is a structural diagram illustrating an embodiment of a printer that is a printing apparatus using the present invention. The printer 2 shown in FIG. 1 is a printing apparatus that uses the present invention; this apparatus feeds the printing medium with a paper feed roller 33 to the printing position and performs printing processing. When the rear end of the printing medium reaches the vicinity of the paper feed roller 33, the printing apparatus performs a processing of correcting the position of the printing medium after the paper feed operation on the basis of a predetermined condition. In the printing apparatus, the position correction processing is ended when the front-rear relationship of the printing medium position and target position is reversed. As a result, a paper feed operation performed when the rear end of the printing medium is positioned in the vicinity of a paper feed roller can be conducted accurately without hindering the printing operation.

The printer 2 is, for example, an ink jet printer that executes printing processing according to a printing instruction from a host computer 1 shown in FIG. 1. The host computer 1 is a host device of the printer 2 and constituted, for example, by a personal computer. The host computer 1 is provided with a printer driver (not shown in the figure) for the printer 2, and when a printing request is issued, printing data for the printer 2 are generated in the printer driver and sent to the printer 2. The printing data include image data of the printing object image and various control commands for controlling the printing processing.

As shown in FIG. 1, the printer 2 is provided with an I/F 21, a CPU 22, a ROM 23, and a RAM 24 constituting a control unit of the printer. The I/F 21 is a component that serves as an interface with the host computer 1, for example, to receive the printing data. The ROM 23 stores data or various control programs necessary for performing control with the CPU 22.

The RAM 24 saves the received printing data and also temporarily saves various data necessary for performing control with the CPU 22. In addition, the RAM 24 appropriately saves a value of the below-described position counter 28 and a cumulated value thereof and functions as a storage means for storing position information of paper sheet P that is a recording medium of the printer 2. The CPU 22 is a control device that causes the printer to execute printing that has been instructed by the host computer 1 according to the received printing data. More specifically, the CPU 22 interprets the control commands contained in the printing data, instructs the operations of the below-described conveying devices and so on, and also transfers the image data contained in the printing data to the below-described head 36 at a predetermined timing and instructs the printing processing on the paper sheet P. A specific feature of this printer 2 is in a paper feed control of the paper sheet P that is performed by the CPU 22, more specifically position correction control of the paper sheet P after the paper feed operation, and specific contents of this feature will be described below. The abovementioned processing performed by the CPU 22 is executed based on a programs and data stored in the ROM 23.

The above-described components are connected to each other with a bus and also connected to various below-described components of a mechanical unit of the printer 2.

As shown in FIG. 1, the printer 2 is provided with a carriage motor drive circuit 25, a head drive circuit 26, a paper feed motor drive circuit 27, a position counter 28, a carriage motor 29, a paper feed motor 30, a paper sensor 31, an encoder 32, a paper feed roller 33, a driven roller 34, a carriage 35, a head 36, and a discharge roller 37, and these components constitute the mechanical unit of the printer 2. The mechanical unit is mainly composed of components that perform the conveying processing of the paper sheet P and the printing processing on the paper sheet P. The components that mainly perform the conveying processing include the paper feed roller 33 that feeds the supplied paper sheet P, the paper feed motor 30 constituted by a DC motor that rotates the paper feed roller 33, the paper feed motor drive circuit 27 that drives the paper feed motor 30, the discharge roller 37 that is rotary driven by the paper feed motor 30 and discharges the paper sheet P, and a driven roller 34 that forms a pair with the paper feed roller 33, receives a pushing force onto the paper feed roller 33, and feeds the paper sheet P. Further, the encoder 32 that is a rotary encoder is provided at the paper feed roller 33, and the rotation of the paper feed roller 33 is thereby detected. The position counter 28 inputs the detection pulses that have been detected by the encoder 32 and counts the number of pulses. The paper sensor 31 detects the presence of the paper sheet P disposed before the paper feed roller 33 in the conveying direction of the paper sheet P and can be constituted by an optical sensor or a contact-type sensor.

The head 36 is the component that performs the printing processing. In the head 36, a nozzle row is provided for each ink color, and as the head 36 moves in the main scanning direction, ink ejection is successively performed according to the data transferred from the control unit and printing is executed on the paper sheet P. The head drive circuit 26 is a drive circuit for ink ejection by the head 36. The carriage 35 serves to move the head 36 in the main scanning direction; the carriage carries the head 36 and is moved by the carriage motor 29. The carriage motor 29 is driven by the carriage motor drive circuit 25.

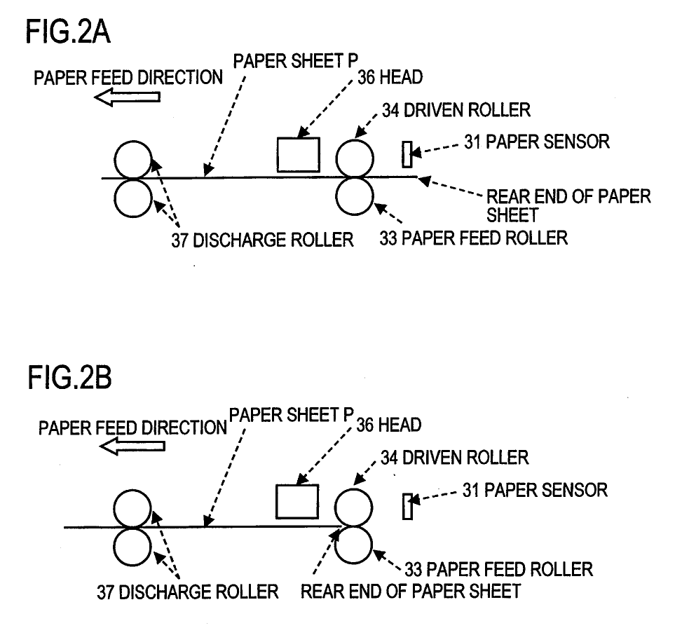

FIGS. 2A and 2B are side views schematically showing the conveying system of the printer 2. The above-described conveying units, namely, the paper sensor 31, paper feed roller 33 and driven roller 34, and discharge roller 37 are disposed in the order of description from the upstream side in the paper feed direction (conveying diction of the paper sheet P), as shown in FIGS. 2A and 2B. The head 36 that performs the printing processing is disposed between the paper feed roller 33 and discharge roller 37, and the printing processing is performed on a portion of the paper sheet P that is positioned below the head.

FIG. 2A shows a state in which the paper sheet P is held by the paper feed roller 33, driven roller 34, and discharge roller 37 from both sides. In this case, the rear end of the paper sheet P (“rear end of the paper sheet” in the figure) is positioned upstream of the paper feed roller 33. In this example, the paper sensor 31 detects the presence of the paper sheet.

FIG. 2B shows a state in which the feed of the paper sheet P is advanced, the rear end of the paper sheet P (“rear end of the paper sheet” in the figure) separates from the paper feed roller 33 and driven roller 34, and the rear end of the paper sheet is positioned downstream of the paper feed roller 33. In this case, the paper sensor 31 detects the absence of the paper sheet. Further, in the state shown herein, the printing processing on the paper sheet P may be performed depending on the case.

As mentioned above, a specific feature of the printer 2 having the above-described configuration is in the conveying processing of the paper sheet P. Therefore, the explanation of the contents of processing performed when the printer 2 receives a printing instruction will be below focused on the conveying processing.

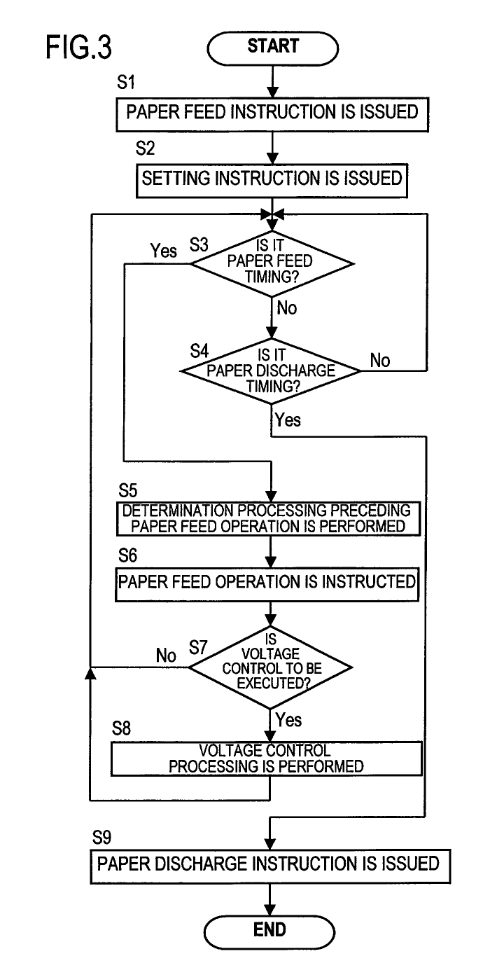

FIG. 3 is a flowchart showing an example of the contents of processing relating to the conveying processing performed by the CPU 22. When printing data are received from the above-described host computer 1, the printer 2 starts a processing relating to the received printing data, and the CPU 22 instructs the feed of the paper sheet P that will be used for printing (step S1). Upon receiving the instruction, the paper feed unit (not shown in the figure) of the mechanical unit executes a paper feed operation and conveys the paper sheet P to a predetermined position. Then, the CPU 22 instructs setting the paper sheet P to the first position (step S2). According to this instruction, the paper feed motor 30 is driven via the paper feed motor drive circuit 27, and the paper sheet P is conveyed to the predetermined position by the paper feed roller 33 and driven roller 34. More specifically, a portion of the paper sheet P that will be the first to be printed on is set so as to come to the printing position (position of the head 36). On such setting, the CPU 22 grasps a printing start position in the paper sheet P from the control command contained in the printing data and determines a position to which the leading (front) end of the paper sheet P is to be moved. Then, this position is represented by the distance from the above-described paper sensor 31, that is, is represented by the number of detected pulses that are detected by the encoder 32 after the leading end has passed by the paper sensor 31, and the drive of the paper feed roller 33 corresponding to this number of pulses is instructed.

Where the carriage 35 and head 36 are then driven and the printing processing is executed on the predetermined range of the paper sheet P according to the printing instruction from the CPU 22, the CPU 22 performs the paper feed operation or paper discharge operation based on next printing data. The paper feed operation is an operation of conveying the paper sheet P to the next printing position, without completing the printing processing of the paper sheet P, and the paper discharge operation is an operation of discharging the paper sheet P after completing the printing processing of the paper sheet P.

In a case where the paper feed operation is performed (Yes in step S3), the CPU 22 initially executes a determination processing preceding the paper feed operation (step S5). This processing is executed to determine whether to perform the control of voltage applied to the paper feed motor 30 after the paper feed operation, in other words, whether to perform a position adjustment processing of the paper sheet P after the paper feed operation. Specific contents of the determination processing preceding the paper feed operation will be described below. The results of the determination are saved in the RAM 24.

The CPU 22 then instructs the paper feed operation according to the instruction of printing data (step S6). According to this instruction, the paper feed motor 30 is driven via the paper feed motor drive circuit 27, and the paper sheet P is conveyed to the predetermined position by the paper feed roller 33 and driven roller 34. More specifically, because the feed amount is grasped from the printing data, a voltage is applied to the paper feed motor 30 so as to move the paper sheet by the number of detection pulses of the encoder 32 corresponding to the feed amount.

Once the paper feed operation is completed, the CPU 22 refers to the results of the above-described determination processing preceding the paper feed operation and determines whether the above-mentioned voltage control is to be executed (step S7). Where the determination results indicate that the voltage control is not to be executed (No in step S7), the processing moves to step S3. The printing processing is then executed in the above-described manner and a transition is made to the paper feed operation or discharge operation according to the next printing data.

In a case where the voltage control is to be executed (Yes in step S7), the CPU 22 executes the voltage control processing (step S8). This processing is a position adjustment processing of the paper sheet P performed when the rear end of the paper sheet P reaches the vicinity of the paper feed roller 33. The specific contents of this processing will be described below.

Where the voltage control processing is completed, the processing moves to step S3, the printing processing is then executed in the above-described manner, and a transition is made to the paper feed operation or discharge operation according to the next printing data.

In a case where a transition is made to the paper feed operation, the processing from the above-described step S5 is executed in a similar manner. The paper feed operation and printing processing are thus repeatedly executed.

At a point in time in which the printing data instruct the discharge of paper (Yes in step S4), the CPU 22 instructs the mechanical unit to discharge the paper sheet P (step S9). According to this instruction, the paper feed motor 30 is driven via the paper feed motor drive circuit 27, the paper feed roller 33, driven roller 34, and discharge roller 37 are rotated, and the paper sheet P is discharged from the printer 2.

The printing is thus executed in response to the printing instruction received from the host computer 1.

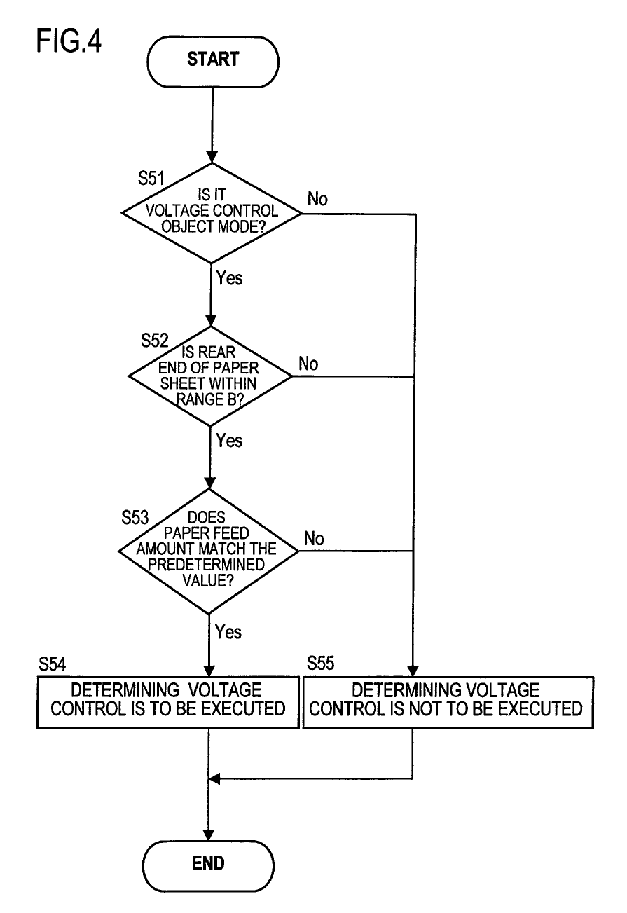

The above-described determination processing preceding the paper feed operation will be described below in greater details. FIG. 4 is a flowchart illustrating by way of example the sequence of the determination processing preceding the paper feed operation. In the determination processing preceding the paper feed operation, the CPU 22 initially determines whether the mode of printing instructed by the host computer 1 is a printing mode that is the object of the voltage control processing (step S51).

The voltage control processing is a position adjustment processing of the paper sheet P that is performed when the rear end of the paper sheet P reaches the vicinity of the paper feed roller 33 in order to correct the position of the paper sheet P after the paper feed operation, implement the subsequent printing processing in a correct position, and prevent the print quality from deteriorating. Therefore, such as processing is desired to be implemented in a case where the printing processing has to be also executed when the rear end of the paper sheet P has reached the vicinity of the paper feed roller 33 and a high-quality output is required. As a result, the printing mode that is the object of this processing includes, for example, a marginless printing mode, a high-quality printing mode, and a printing mode using high-quality paper.

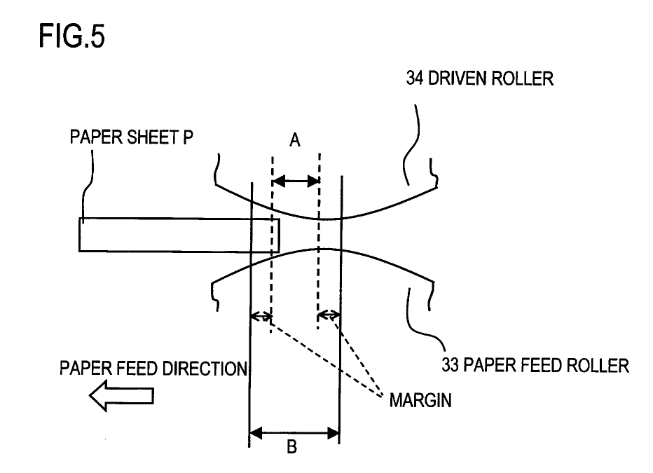

The CPU 22 grasps the required printing mode from the received printing data and determines whether this mode is a printing mode that is the object.

Where the results indicate that this is a printing mode that is the object (Yes in step S51), the CPU 22 then determines whether the rear end of the paper sheet P is positioned in a predetermined range in the vicinity of the paper feed roller 33 (step S52). FIG. 5 is a side enlarged view of the vicinity of the paper feed roller 33. In FIG. 5, the range denoted by symbol A is a range in which the rear end of the paper sheet P is separated from the paper feed roller 33; this range is obtained empirically. The range denoted by symbol B is the above-descrived predetermined range in the vicinity of the paper feed roller 33 that is obtained by adding a margin (for example, 2 mm on each side) to the range A at both sides in the paper feed direction. In a case where the rear end of the paper sheet P after the paper feed operation is positioned in the range B, the paper sheet P is in a state of separation from the paper feed roller 33, and the position of the paper sheet P can be shifted form the target position, for example, by a force applied to the paper sheet P from the roller when the paper sheet separates from the paper feed roller 33, as described hereinabove. In such a case, the above-described voltage control processing (position correction processing) is necessary.

The CPU 22 saves in the aforementioned RAM 24 the cumulative value of a count of the position counter 28 after the rear end of the paper sheet P has passed by the position of the paper sensor 31, adds a movement amount resulting from the present paper feed operation (number counted by the position counter 28) to the cumulative value, calculates the value obtained as a distance, and determines whether the rear end of the paper sheet P after the present paper feed operation is positioned in the range B. The movement amount (paper feed amount) resulting from the present paper feed operation is grasped from the printing data.

In a case where the results of the determination demonstrate that the rear end of the paper sheet P after the present paper feed operation is positioned in the range B (Yes in step S52), the CPU 22 determines whether the movement amount (paper feed amount) resulting from the present paper feed operation matches a predetermined value (step S53). In a case where the printing is performed continuously in the paper feed direction of the paper sheet P, a range (length in the paper feed direction) in which the printing operation is completed in one scanning cycle of the head 36 is set in advance correspondingly to the resolution. Therefore, the amount of movement of the paper sheet P (paper feed amount) that is necessary for the next printing processing becomes the length thereof (the above predetermined value). In this case, because the printing processing is conducted continuously, the images are superimposed or separated and quality is deteriorated unless the position after the paper feed operation is correct.

In a case where a region where no printing is performed is present in the paper sheet P and the next printing location jumps in the paper feed direction, the paper feed amount becomes large and even if the position after the paper feed operation is somewhat incorrect, the probability of the deterioration such as superposition on the preceding image is low.

Therefore, the CPU 22 checks whether the paper feed amount instructed by the present printing data matches a value that has been set correspondingly to the resolution in the printing, this value being the length that has been set in advance according to the resolution, and determines that position correction is to be performed when there is a match. In a case of no match, the CPU determines that the printing position is jumped as described above and determines that no position correction is to be performed.

As a result of this determination, in a case where the paper feed amount resulting from the present paper feed operation matches the predetermined value (Yes in step S53), the CPU 22 determines that the above-mentioned voltage control processing is to be executed (step S54).

In a case where the result of any one of the above-described three determinations (S51, S52, and S53) is No, the CPU 22 determines that the above-mentioned voltage control processing will not be executed (step S55).

The determination processing preceding the paper feed operation is thus performed and whether or not to execute the voltage control processing is saved. In this processing, that is, in a case where the present printing mode is a target printing mode in which the voltage control processing is performed, the rear end position of the paper sheet P after the present paper feed is in the range B, and the present paper feed amount is the above-mentioned predetermined value, it is determined that the voltage control processing be executed.

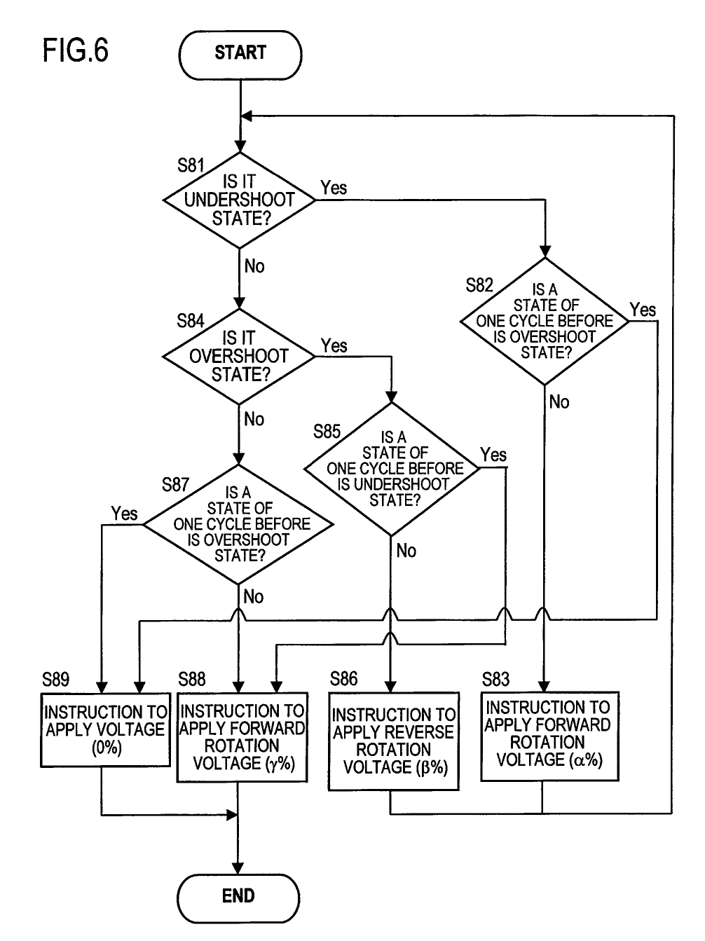

The aforementioned voltage control processing will be described below in greater detail. FIG. 6 is a flowchart illustrating by way of example the sequence of the voltage control processing. In a case where it is determined that the voltage control processing is to be executed, the CPU 22 grasps the position of the rear end of the paper sheet P after the paper feed operation.

The CPU 22 takes the position of the paper sheet P after the aforementioned setting as a start point (0) and saves in the RAM 24 the cumulative value of the movement amount resulting from the subsequent paper feed operation as a cumulative value of the counter of the position counter 28. Then, each time the paper feed operation ends, the counter value of the position counter 28 is stored in the RAM 24 and the value of the position counter 28 is reset. Therefore, the value of the position counter 28 after each paper feed operation indicates the amount of movement in its paper feed operation.

The above-mentioned grasping the rear end position of the paper sheet P means grasping as to whether the paper sheet P has moved according to the paper feed amount that corresponds to the instruction of printing data and being located on the target position. More specifically, a value obtained by calculating the instructed paper feed amount as a detected pulse number of the encoder 32 is compared with a value of the position counter 28 after the paper feed operation. If the two values match, the rear end of the paper sheet P is determined to be in the target position, if the value of the position counter 28 is smaller, the rear end of the paper sheet P is determined to be positioned before (before in the paper feed direction), the target position, that is, it is determined to be in an undershoot state, and if the value of the position counter 28 is larger, the rear end of the paper sheet P is determined to be positioned after (after in the paper feed direction) the target position, that is, it is determined to be in an overshoot state.

In a case where the undershoot state is determined (Yes in step S81) or the overshoot state is determined (Yes in step S84) as a result of grasping the rear end position of the paper sheet P, the CPU 22 performs the position correction control to cancel the state with displacement from the target position and move the rear end of the paper sheet P to the target position. This position correction control can be performed repeatedly till the predetermined condition such as movement to the target position is fulfilled, but in a case where the back and forth relationship (in the paper feed direction) of the actual position and target position has been reversed after the correction, the printer 2 does not perform the above-described position correction control any more. This is an important feature of the printer 2.

Therefore, in a case of the above-mentioned undershoot state or overshoot state, initially, a state of one cycle before, that is, a state before the position correction control of the previous cycle, is checked. More specifically, in a case of the undershoot state, it is checked whether the state of one cycle before is the overshoot state (step S82). The CPU 22 stores the state after the position correction in the RAM 24.

In a case where the checking results indicate that the state of one cycle before is not the overshoot state, for example, in a case where the present cycle is the initial position correction (No in step S82), an instruction is issued to apply a predetermined voltage (a %) in the forward rotation direction to the paper feed motor 30 so as to advance the paper sheet P forward in the conveying direction with the object of performing the position correction control (step S83). Here, the above-mentioned predetermined voltage that is to be applied, that is, the voltage for moving the paper sheet forward in the conveying direction, is a value of a % (for example 4%) of a maximum voltage that can be applied to the paper feed motor 30, and this voltage is set in advance based on test results or the like.

The predetermined voltage is applied to the paper feed motor 30 via the paper feed motor drive circuit 27 in response to this instruction, and the position correction of the paper sheet P is performed. The processing then returns to step S81.

In a case where the state of one cycle before is the overshoot state (Yes in step S82), as described hereinabove, the position correction control is not performed and, therefore, the processing advances to step S89 to end this control.

In a case where the present state is the overshoot state (Yes in step S84), it is checked whether the state of one cycle before is the undershoot state (step S85).

In a case where the checking results indicate that the state of one cycle before period is not the undershoot state, for example, in a case where the present cycle is the initial position correction (No in step S85), an instruction is issued to apply a predetermined voltage (130) in the reverse rotation direction to the paper feed motor 30 so as to withdraw the paper sheet P backward with respect to the conveying direction with the object of performing the position correction control (step S86). Here, the abovementioned predetermined voltage that is to be applied, that is, the voltage for moving the paper sheet backward with respect to the conveying direction, is a value of (3% (for example 6%) of a maximum voltage that can be applied to the paper feed motor 30, and this voltage is set in advance based on test results or the like.

The predetermined voltage is applied to the paper feed motor 30 via the paper feed motor drive circuit 27 in response to this instruction, and the position correction of the paper sheet P is performed. The processing then returns to step S81.

In a case where the state of one cycle before is the undershoot state (Yes in step S85), as described hereinabove, the position correction control is not performed and, therefore, the processing advances to step S88 to end the control.

In a case where the rear end of the paper sheet P is in the target position in a state after the paper feed operation, or after the position correction processing (No in step S84), the position correction processing is ended and the processing of saving the position is performed. This processing differs depending on the state before the paper sheet P is in the target position.

When it is checked whether the state of one cycle before, that is, the state before the position correction control, is the overshoot state (step S87) and the state is found to be the overshoot state (Yes in step S87), the processing moves to step S89. Where the state is not the overshoot state (No in step S87), the processing moves step S88. Where the target position is assumed after the paper feed operation and no position correction is performed, the processing moves to step S88.

In step S88, an instruction is issued to apply a predetermined voltage (y %) in the forward rotation direction to the paper feed motor 30, as a processing of saving the position of the paper sheet P (step S88). Here, the abovementioned predetermined voltage that is to be applied is a value of 7% (for example 4%) of a maximum voltage that can be applied to the paper feed motor 30, and this voltage is set in advance based on test results or the like. The predetermined voltage (7%) in the forward rotation direction is a voltage serving to suppress the backlash caused by a play of gears that transfer power from the paper feed motor 30 to the paper feed roller 33, and this predetermined voltage has a value sufficient to prevent the paper sheet P from moving. The predetermined voltage (7%) in the forward rotation direction can be applied after the paper feed operation even when the voltage control processing (step S8) is not performed.

In step S89, an instruction is issued to apply a predetermined voltage (0%) to the paper feed motor 30, as a processing of saving the position of the paper sheet P (step S89). Thus, no voltage is applied to the paper feed motor 30. When a transition is made to this step S89, the state attained before the present position is assumed is the overshoot state and it is highly probable that a force acts to push out the paper sheet P forward in the paper conveying direction. Therefore, if the above-described predetermined voltage (7%) in the forward rotation direction is applied, the overshoot state can be assumed again. Accordingly, the applied predetermined voltage is made 0%.

Thus, the voltage control processing (step S8) is executed and the printing processing is executed mostly in the target position. In a case the undershoot state remains as is or the overshoot state remains as is even after the above-described position correction has been repeatedly implemented, the position correction processing is ended at the number of cycles of the above-described position correction processing or the time and a transition is made to step S88 or S89.

As described hereinabove, in the printer 2 of the present exemplary embodiment, when the rear end of the paper sheet P is positioned in the vicinity of the paper feed roller 33 where the paper sheet can shift from the target position after the paper feed operation, the position correction processing is performed to match the paper sheet position with the target position and this position correction processing is ended when the back and forth relationship of the rear end position of the paper sheet P and the target position is reversed. Therefore, the paper feed operation conducted when the rear end of the paper sheet P is positioned in the vicinity of the paper feed roller can be performed with high accuracy and the occurrence of vibrations or noise caused by repeated execution of the position correction processing and repeated operation of reversing the back and forth relationship can be inhibited. Further, no unnecessarily long time is required for the position correction processing. Therefore, certain position accuracy can be ensured, deterioration of printing quality can be prevented, and good printing can be executed without adversely affecting the throughput or other characteristics of the printer 2.

The voltage applied to maintain the position after the position correction processing is determined by taking into account the backlash or the fact that the paper sheet P is pushed out forward. As a result, the position after the paper feed operation can be accurately preserved.

The above-described position correction processing is performed in a case of a predetermined printing mode and in a case of a predetermined paper feed amount, and where such an accurate position is not required, the position correction processing is not performed to avoid unnecessary increase in processing time.

In the above-descried exemplary embodiment, the position correction processing is ended when the back and forth relationship of the rear end position of the paper sheet P and the target position is reversed, that is, the position correction processing is ended when the reversal of the back and forth relationship of the rear end position of the paper sheet P and the target position has occurred once, but the position correction processing may be also ended after a predetermined number (two or more) of reversal cycles. This predetermined number is preferably determined within a range in which a throughput or other characteristics of the above-described printer are not adversely affected. The effect obtained in this case is similar to that described hereinabove.

Further, in the above-described exemplary embodiment, the control of conveying processing of the paper sheet P including the position correction processing is executed by the CPU 22 according to a program, but this control may be also executed by hardware or by a combination of hardware and software.

1. A printing apparatus that feeds a printing medium to a printing position and executes a printing processing, comprising:
a conveying unit that performs conveying of the printing medium including the paper feed operation and that has a paper feed roller provided before a position in which the printing processing is performed in the conveying direction; and
a control unit that controls the printing processing and the conveying processing,
wherein the control unit executes a position correction processing for moving a position of a rear end of the recording medium to a target position in a case where the position of the rear end is shifted from the target position when the position of the rear end after the paper feed operation is within a predetermined range in the vicinity of the paper feed roller and ends the position correction processing when the number of times the back and forth relationship of the rear end position and the target position in the conveying direction is reversed reaches a predetermined number of times.

2. The printing apparatus according to claim 1, wherein the predetermined number of times the back and forth relationship is reversed is one.

3. The printing apparatus according to claim 2, wherein
the position correction processing is performed by voltage application to a motor that rotates the paper feed roller, and
once the position correction processing ends, in a case where the rear end is before the target position in the conveying direction prior to the position correction processing, a voltage of a predetermine value that causes no movement of the printing medium and that is in the direction of causing the paper feed roller to rotate in the conveying direction is applied to the motor, and in a case where the rear end is after the target position in the conveying direction prior to the position correction processing, the voltage of the predetermined value is not applied.

4. The printing apparatus according to claim 1, wherein the position correction processing after the paper feed operation is not performed in a case where a paper feed amount in the paper feed operation is not a predetermined value.

5. The printing apparatus according to claim 1, wherein the position correction processing is not executed in a case where the printing processing is not performed in a predetermined printing mode.

6. A printing medium conveying control method in a printing apparatus that feeds a printing medium to a printing position and executes a printing processing,
wherein the printing apparatus is provided with a conveying unit that performs conveying of the printing medium including the paper feed operation and that has a paper feed roller provided before a position in which the printing processing is performed in the conveying direction, and a control unit that controls the printing processing and the conveying processing, and
the control unit executes a position correction processing for moving a position of a rear end of the recording medium to a target position in a case where the position of the rear end is shifted from the target position when the position of the rear end after the paper feed operation is within a predetermined range in the vicinity of the paper feed roller, and ends the position correction processing when the number of times the back and forth relationship of the rear end position and the target position in the conveying direction is reversed reaches a predetermined number of times.

7. The printing apparatus according to claim 2, wherein the position correction processing after the paper feed operation is not performed in a case where a paper feed amount in the paper feed operation is not a predetermined value.

8. The printing apparatus according to claim 3, wherein the position correction processing after the paper feed operation is not performed in a case where a paper feed amount in the paper feed operation is not a predetermined value.
